(19) United States
(12) Patent Application Publication
(10) Pub. No.: US 2026/0094144 A1
(43) Pub. Date: Apr. 2, 2026

(54) METHODS AND SYSTEMS FOR RELAYING A PAYMENT CARD DETAIL DURING A TELEPHONE CALL BETWEEN A CUSTOMER'S TELEPHONE AND A VENDOR'S TELEPHONE

(71) Applicant: CBSM HOLDINGS LTD, Hove (GB)

(72) Inventor: Cameron May, Reading (GB)

(73) Assignee: CBSM HOLDINGS LTD, Hove (GB)

(21) Appl. No.: 19/076,499

(22) Filed: Mar. 11, 2025

(30) Foreign Application Priority Data
Sep. 27, 2024 (GB) 2414255.6

(51) Int. Cl. G06Q 20/32; G06Q 20/40

(52) U.S. Cl. CPC G06Q 20/3227; G06Q 20/40

(57) ABSTRACT

There is provided a method for relaying a payment card detail during a telephone call between a customer’s telephone and a vendor’s telephone, the customer’s telephone storing the payment card detail therein, the method comprising: initiating a telephone call between the customer and the vendor; the customer’s telephone receiving a predetermined input; during the telephone call, the customer’s telephone accessing the payment card detail stored in the customer’s telephone based on the predetermined input; and the customer’s telephone audibly relaying to the vendor the accessed payment card detail, wherein audibly relaying to the vendor the accessed payment card detail comprises the customer’s telephone converting the accessed payment card detail into a series of dial tones containing the payment card detail and audibly relaying the series of dial tones during the telephone call, wherein the series of dial tones are representative of the accessed payment card detail.

### CROSS-REFERENCE TO RELATED APPLICATIONS

This application claims priority to GB Patent Application No. 2414255.6 filed on September 27, 2024, the disclosure of which is hereby incorporated by reference in its entirety for all purposes.

### TECHNICAL FIELD

The present disclosure relates to a method for relaying a payment card detail during a telephone call between a customer’s telephone and a vendor’s telephone, and particularly to a method for audibly relaying the payment card detail by the customer’s telephone converting the payment card detail into a series of dial tones containing the payment card detail and audibly relaying the series of dial tones during the telephone call. The present disclosure also relates to a non-transitory computer readable medium tangibly carrying computer executable instructions for carrying out the same.

### BACKGROUND

In many situations, a customer may be required to make a payment during a telephone call with a vendor. For example, this may be required when making a purchase for goods or services during a telephone call with the vendor. In these situations, with the methods and systems currently known in the art, the customer is required to retrieve, during the call, their payment card and relay the payment card details required by the vendor to authorize the payment.

However, as this is carried out during the telephone call with the vendor and therefore usually whilst the customer is holding their telephone, this normally results in a physical limitation during the call as the customer has to retrieve the payment card and hold their telephone at the same time. As the payment card is typically initially stored within a wallet, retrieving the payment card during the call tends to prove physically challenging in many situations, especially if the customer is involved in other activities during the phone call such as walking, running or cycling.

Furthermore, with currently known methods and systems, the customer is required to read the card payment details aloud into their phone to relay the card payment details to the vendor. This presents significant security risks especially if the customer is attempting to hold the telephone call in a public space as a third party may eavesdrop and obtain the customer’s payment card details.

In view of the above, there is a need for a physically convenient and secure method for relaying a payment card detail during a telephone call between a customer’s telephone and a vendor’s telephone. There is also a need for a physically convenient and secure system for relaying a payment card detail during a telephone call between a customer’s telephone and a vendor’s telephone.

### SUMMARY OF THE DISCLOSURE

Accordingly, it is an object of the present disclosure to provide a physically convenient and secure method for relaying a payment card detail during a telephone call between a customer’s telephone and a vendor’s telephone. It is also an object of the present disclosure to provide a physically convenient and secure system for relaying a payment card detail during a telephone call between a customer’s telephone and a vendor’s telephone.

These objectives and others are achieved with the method of Claim 1 and the non-transitory computer readable medium of Claim 11.

Preferred embodiments are recited in the dependent claims.

According to a first aspect, there is provided a method for relaying a payment card detail during a telephone call between a customer’s telephone and a vendor’s telephone, the customer’s telephone storing the payment card detail therein, the method comprising: initiating a telephone call between the customer and the vendor; the customer’s telephone receiving a predetermined input; during the telephone call, the customer’s telephone accessing the payment card detail stored in the customer’s telephone based on the predetermined input; and the customer’s telephone audibly relaying to the vendor the accessed payment card detail, wherein audibly relaying to the vendor the accessed payment card detail comprises the customer’s telephone converting the accessed payment card detail into a series of dial tones and audibly relaying the series of dial tones during the telephone call, wherein the series of dial tones are representative of the accessed payment card detail..

In certain implementations, converting the accessed payment card detail into a series of dial tones may comprise using a tone generator on the customer’s telephone.

In certain implementations, the tone generator is a dual tone multi-frequency generator.

The series of dial tones may be generated using a dual tone multi-frequency generator. The dual tone multi-frequency generator may convert payment card detail(s) stored on the customer’s telephone in the form of a string (for example containing text and/or numbers) into a series of dial tones. The dial tones may then be audibly relayed to the vendor’s telephone. The vendor’s telephone may then optionally convert the series of dial tones, using an interactive voice response system, into synthesized speech that can be understood by the vendor. The dial tones may be dual tone multi-frequency tones.

Optionally, each of the dual tone multi-frequency dial tones may comprise two tones at two different frequencies. The two tones may optionally be sequentially relayed to the vendor’s telephone, such that each dial tone representing a number is split into two tones that are sequentially sent to the vendor’s telephone. Advantageously, this may increase the clarity of dial tones, increasing the accuracy of the relayed payment card detail, in turn increasing the likelihood of the vendor’s telephone correctly interpreting the payment card detail.

Optionally, the dial tones may be single tone single-frequency tones. The series of single tone dial tones may be generated using a single tone generator on the customer’s telephone. Advantageously, using single tones may reduce the processing power required to generate the dial tones on the customer’s telephone and/or the processing power required to interpret the dial tones on the vendor’s telephone. Single tones may also be relayed across to the vendor’s telephone in a shorter amount of time, increasing the speed at which the payment card detail are relayed. This may reduce the likelihood of the payment card detail being accessed by third parties during the relaying of the payment card detail.

Optionally, each of the dial tones may comprise more than two tones, or may comprise more than two frequencies. Each of the dial tones comprising more than two tones and/or frequencies may be generated using a multi-tone generator on the customer’s telephone. Advantageously, using dial tones comprising more than two tones and/or frequencies may increase the accuracy of the relayed payment card detail, increasing the likelihood of the vendor’s telephone correctly interpreting the payment card detail.

In certain implementations, the series of dial tones may be a series of keystroke dial tones.

As the customer’s telephone stores the payment card detail therein and audibly relays the payment card detail to the vendor during the telephone call, the customer does not need to retrieve their payment card and therefore does not need to physically handle the payment card during the telephone call. This means that the customer may audibly relay their payment card detail whilst only interacting with their telephone. This therefore provides for a physically convenient method for relaying a payment card detail during a telephone call between a customer’s telephone and a vendor’s telephone.

Additionally, as the customer’s telephone itself audibly relays the payment card detail to the vendor, the customer themselves need not speak the payment card detail. This therefore provides for increased security as a third party cannot eavesdrop and obtain the relayed payment card detail. Hence, the method is also a secure method for relaying a payment card detail during a telephone call between a customer’s telephone and a vendor’s telephone.

In certain implementations, receiving the predetermined input comprises the customer inputting the predetermined input using the customer’s telephone.

With such implementations, the customer may physically conveniently select when to audibly relay their payment card detail without having to physically obtain their payment card. For example, upon prompting from the vendor, the customer may input the predetermined input into their phone such that the phone audibly relays the payment card detail. Such implementations provide for a physically convenient manner to selectively relay payment card details.

In certain implementations, the predetermined input comprises the customer selecting a key or a sequence of keys on the customer’s telephone.

With such implementations, the customer may select in a physically conveniently manner when to audibly relay their payment card detail without having to physically obtain their payment card. Such implementations provide for a physically convenient manner to selectively relay payment card details.

In certain implementations, receiving the predetermined input comprises the vendor inputting the predetermined input using the vendor’s telephone and the vendor’s telephone relaying the inputted predetermined input to the customer’s telephone.

With such implementations, the vendor may select when to audibly receive the customer’s payment card detail without having to request the payment card detail from the customer or without having the customer physically obtain their payment card. For example, once the vendor is ready to receive the payment card detail, the vendor may input the predetermined input into their phone thereby triggering the customer’s phone to audibly relay the payment card detail to the vendor. Such implementations provide for a physically convenient manner to selectively relay payment card details with minimum physical requirements from the customer.

In certain implementations, the predetermined input comprises the vendor selecting a key or a sequence of keys on the vendor’s telephone.

With such implementations, the vendor may select in a physically convenient manner when to audibly receive the customer’s payment card detail without requiring the customer to physically obtain their payment card. Such implementations provide for a physically convenient manner to selectively relay payment card details.

In certain implementations, the method further comprises: the customer’s telephone receiving a second predetermined input; during the telephone call, the customer’s telephone accessing a second payment card detail stored in the customer’s telephone based on the second predetermined input; and the customer’s telephone audibly relaying to the vendor the accessed second payment card detail, wherein audibly relaying to the vendor the accessed second payment card detail comprises the customer’s telephone converting the accessed second payment card detail into a second series of dial tones and audibly relaying the second series of dial tones during the telephone call, wherein the second series of dial tones are representative of the accessed second payment card detail..

In certain implementations, converting the accessed second payment card detail into a second series of dial tones may comprise using a tone generator on the customer’s telephone.

In certain implementations, the tone generator is a dual tone multi-frequency generator.

In certain implementations, the second series of dial tones may be a series of keystroke dial tones.

With such implementations, two different payment card details may be relayed to the vendor each being selectively relayed by input of the two different predetermined inputs. This results in a convenient way for the vendor to receive the various payment card details when the various details are required.

In certain implementations, the method comprises receiving security authorization from the customer using the customer’s telephone, and, optionally, wherein the security authorization is in the form of receiving a passcode/password, a fingerprint, a retinal-recognition image and/or a facial-recognition image from the customer using the customer’s telephone.

With such implementations, any payment card detail is only relayed once the security authorization from the customer has been received. Accordingly, this increases security as the vendor cannot access any payment card information until the customer specifically authorizes the payment.

In certain implementations, the method comprises receiving the predetermined input comprises receiving the security authorization.

With such implementations, the predetermined input includes the security authorization from the customer. Therefore, the first payment card detail cannot be relayed unless the customer has authorized the relaying of it. Accordingly, this increases security as the vendor cannot access the first payment card detail until the customer specifically authorizes the payment.

In certain implementations, the method comprises converting, using at least one text-to-speech algorithm, the accessed payment card detail to an audible message containing the payment card detail and audibly relaying to the customer the audible message whilst audibly relaying to the vendor the series of dial tones.

Optionally, the audible message comprises synthesized speech describing the first payment card detail.

With such implementations, the customer can at all times hear via their telephone which information is being relayed to the vendor by their telephone. This means that the customer can verify the correct information is being relayed to the vendor and stop the relaying of information at any time during the call for security reasons.

In certain implementations, the customer’s telephone stores a first set of payment card details associated with a first payment card and comprising the accessed payment card detail and a second set of payment card details associated with a second payment card.

With such implementations, the customer’s telephone can store two payment cards therein. Accordingly, the customer has greater freedom in choosing how to pay (i.e. which payment card).

According to a second aspect, there is provided a non-transitory computer readable medium tangibly carrying computer executable instructions for relaying a payment card detail during a telephone call between a customer’s telephone and a vendor’s telephone, the customer’s telephone storing the payment card detail therein, the instructions being executable to implement: initiating a telephone call between the customer and the vendor; the customer’s telephone receiving a predetermined input; during the telephone call, the customer’s telephone accessing the payment card detail stored in the customer’s telephone based on the predetermined input; and the customer’s telephone audibly relaying to the vendor the accessed payment card detail, wherein audibly relaying to the vendor the accessed payment card detail comprises the customer’s telephone converting the accessed payment card detail into a series of dial tones and audibly relaying the series of dial tones during the telephone call, wherein the series of dial tones are representative of the accessed payment card detail.

In certain implementations, converting the accessed payment card detail into a series of dial tones may comprise using a tone generator on the customer’s telephone

In certain implementations, the tone generator is a dual tone multi-frequency generator.

In certain implementations, the series of dial tones may be a series of keystroke dial tones.

As the customer’s telephone stores the payment card detail therein and audibly relays the payment card detail to the vendor during the telephone call, the customer does not need to retrieve their payment card and therefore does not need to physically handle the payment card during the telephone call. This means that the customer may audibly relay their payment card detail whilst only interacting with their telephone. This therefore provides for a physically convenient method for relaying a payment card detail during a telephone call between a customer’s telephone and a vendor’s telephone.

Additionally, as the customer’s telephone itself audibly relays the payment card detail to the vendor, the customer themselves need not speak the payment card detail. This therefore provides for increased security as a third party cannot eavesdrop and obtain the relayed payment card detail. Hence, the executable method is also a secure method for relaying a payment card detail during a telephone call between a customer’s telephone and a vendor’s telephone.

According to a third aspect, there is provided a user device comprising: (a) a processor and a memory, wherein the memory is configured to store one or more payment card details, including at least a first payment card detail; (b) a display; (c) a user interface usable by a user to provide input; and (d) a telephone communication device configured to provide two way audio communication; wherein the processor is configured to, as part of a payment detail relay process: (i) establish a communication channel with a vendor via the telephone communication device; (ii) in response to a predetermined input that indicates the start of a transaction, cause one or more graphics associated with the one or more payment card details to display via the display; (iii) create a series of dial tones based on the first payment card detail, wherein the series of dial tones comprise audible signals describing the first payment card detail; and (iv) in response to the user selecting a first graphic of the one or more graphics that is associated with the first payment card detail, via the user interface, audibly relay the series of dial tones over the communication channel.

In certain implementations, creating the series of dial tones may comprise using a tone generator on the customer’s telephone, wherein the tone generator is configured to convert the first payment card detail into the series of dial tones.

In certain implementations, the tone generator is a dual tone multi-frequency generator.

In certain implementations, the series of dial tones may be a series of keystroke dial tones.

In a fourth aspect, there is provided a method for providing a payment detail relay process for a user device, the method comprising, with a processor of the user device: (a) storing one or more payment card details, including at least a first payment card detail, on a memory of the user device (b) establishing a communication channel with a vendor via a telephone communication device of the user device; (c) in response to a predetermined input that indicates the start of a transaction, displaying one or more graphics associated with the one or more payment card details via a display of the user device; (d) creating a series of dial tones based on the first payment card detail, wherein the series of dial tones comprise audible signals describing the first payment card detail; and (e) in response to a user selecting a first graphic of the one or more graphics that is associated with the first payment card detail, via a user interface of the user device, audibly relaying the series of dial tones over the communication channel.

In certain implementations, creating the series of dial tones may comprise using a tone generator on the customer’s telephone, wherein the tone generator is configured to convert the first payment card detail into the series of dial tones.

In certain implementations, the tone generator is a dual tone multi-frequency generator.

In certain implementations, the series of dial tones may be a series of keystroke dial tones.

In a fifth aspect, there is provided a method for relaying a personal information during a telephone call between a user’s telephone and a recipient’s telephone, the user’s telephone storing the personal information therein, the method comprising: initiating a telephone call between the user and the recipient; the user’s telephone receiving a predetermined input; during the telephone call, the user’s telephone accessing the personal information stored in the user’s telephone based on the predetermined input; and the user’s telephone audibly relaying to the recipient the personal information, wherein audibly relaying to the recipient the personal information comprises the user’s telephone converting the accessed personal information into a series of dial tones and audibly relaying the series of dial tones during the telephone call, wherein the series of dial tones are representative of the accessed personal information.

In certain implementations, the user is a customer and/or the recipient is a vendor.

In certain implementations, the personal information is sensitive information.

In certain implementations, converting the accessed personal information into a series of dial tones may comprise using a tone generator on the user’s telephone.

In certain implementations, the tone generator may be configured to generate unique tones for each individual number (e.g., 0, 1, 2, 3, 4, 5, 6, 7, 8, and 9), and/or each individual letter of the roman alphabet, and/or each individual letter of any alphabet, and/or each character represented on a 104-key US QWERTY keyboard (e.g., a comma, a question mark, etc.).

Advantageously, the user may be able to safely relay various forms of personal information across the telephone without a third party being able to eavesdrop and obtain the relayed personal information.

In certain implementations, the tone generator is a dual tone multi-frequency generator.

In certain implementations, the series of dial tones may be a series of keystroke dial tones.

In the first, second, third and fourth aspects, retrieving payment card details may be optional. The first, second, third and fourth aspects may retrieve any form of personal information, for example, sensitive information, personal identification information (e.g., passport details, driver's license details, national insurance number, addresses), passwords, answers to security questions, or any other form of personal information.

### BRIEF DESCRIPTION OF THE DRAWINGS

For a better understanding of the present disclosure and to show how the same may be carried into effect, reference will now be made, by way of example only, to the accompanying drawings, in which:

FIG. 1 shows a first implementation of a method for relaying a payment card detail during a telephone call between a customer’s telephone and a vendor’s telephone;

FIG. 2 shows a second implementation of a method for relaying a payment card detail during a telephone call between a customer’s telephone and a vendor’s telephone; and

FIG. 3 shows an example of a telephone which may be used in accordance with the present disclosure, the telephone showing a first selection screen; and

FIG. 4 shows the telephone of FIG. 3 with a second selection screen.

### DETAILED DESCRIPTION

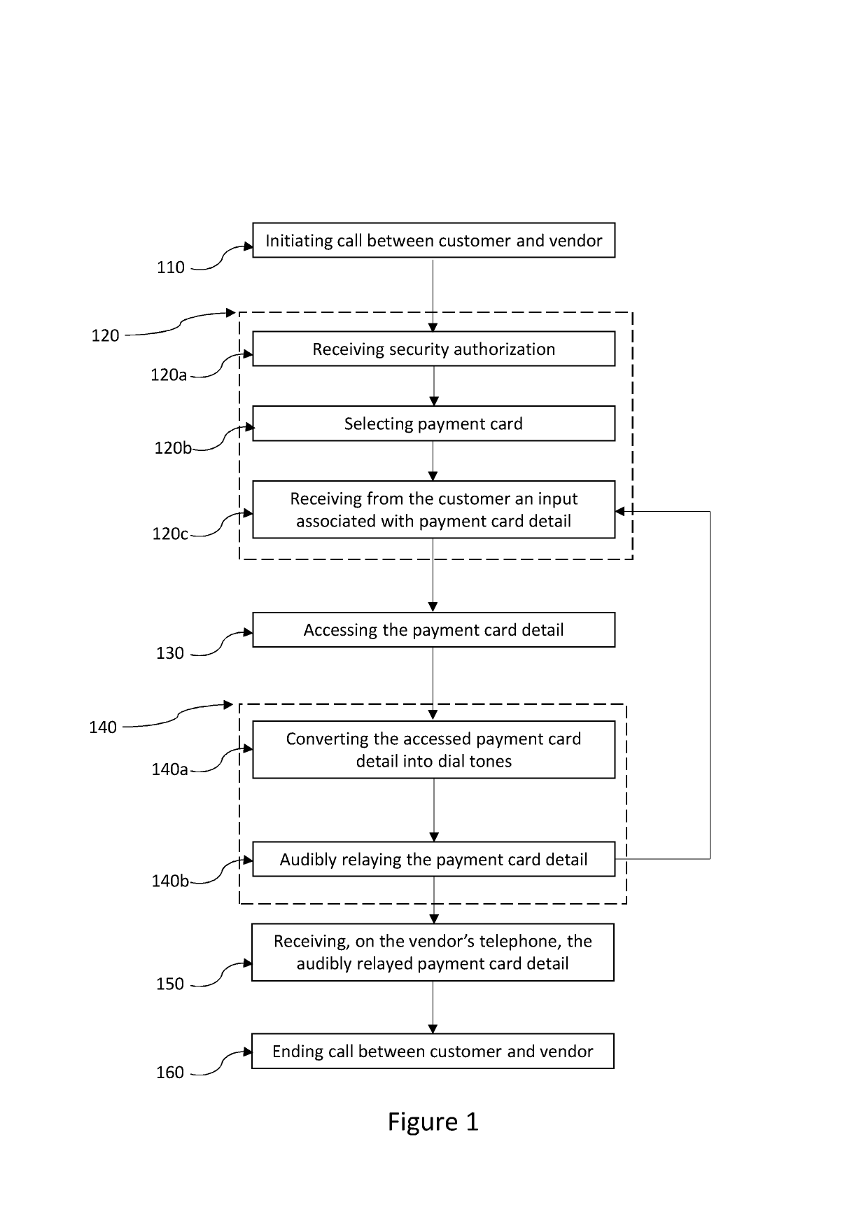

FIG. 1 shows a first implementation of a method for relaying a payment card detail during a telephone call between a customer’s telephone and a vendor’s telephone.

In step 110, a telephone call is initiated between a customer and a vendor using the customer’s telephone and the vendor’s telephone.

In certain implementations, during the telephone call, the customer and the vendor may agree that a payment is required over the telephone. Accordingly, in certain implementations, the customer may wish to provide at least one payment card detail to the vendor during the telephone call. The at least one payment card detail may be used for complete payment for goods/services or for securing a booking.

Thereafter, in step 120, the customer’s telephone receives a predetermined input. In the implementation shown in FIG. 1, the customer’s telephone receives the predetermined input by the customer inputting the predetermined input using the customer’s telephone. For example, the predetermined input may be entered using the customer’s telephone’s user interface such as a touchscreen, microphone and/or camera.

As shown in FIG. 1, the customer’s telephone receiving the predetermined input in step 120 comprises, in step 120a, the customer’s telephone receiving security authorization from the customer. In certain implementations, the security authorization may be in the form of receiving a passcode/password, a fingerprint, a retinal-recognition image and/or a facial-recognition image from the customer using the customer’s telephone.

Receiving security authorization from the customer in step 120a may be the first element of the overall predetermined input received in step 120.

In certain implementations, if the security authorization from the customer is unsuccessful, the customer’s telephone may output an error message to the customer.

If the security authorization from the customer is unsuccessful, the input received by the customer’s telephone would not match the required predetermined input and the customer’s telephone would not proceed to step 130 (described below).

As shown in FIG. 1, the customer’s telephone receiving the predetermined input in step 120 further comprises, in step 120b, the customer’s telephone receiving a selection of a payment card from the customer.

The customer’s telephone stores one or more sets of payment card details therein. For example, the customer’s telephone may store one, two, three, four or five sets of payment card details therein. The one or more sets of payment card details are each associated with a payment card.

For example, at least one set of payment card details or each set of payment card details comprises at least one number and/or at least one date.

In certain implementations, at least one set of payment card details or each set of payment card details comprises: a first number, a second number and a date. Optionally, the first number may be a sixteen-digit number, the second number may be a three-digit number. The at least one set of payment card details or each set of payment card details may optionally further comprise: a second date and/or a string of text, for example, a name.

In step 120b, the customer may select which payment card out of the one or more payment cards that should be relayed to the vendor. For example, the customer may select a numerical key on their telephone to select which payment card to proceed with and/or the customer may select a visual prompt on a screen of the customer’s telephone which represents the payment card, for example, an image of the payment card.

As shown in FIG. 1, the customer’s telephone receiving the predetermined input in step 120 further comprises, in step 120c, the customer’s telephone receiving an input associated with a payment card detail of the selected payment card.

For example, the customer may select an input on their phone which is associated with one of the payment card details in the set of payment card details of the selected payment card.

Thereafter, in step 130, the customer’s telephone accesses the associated payment card detail stored therein and in step 140 relays this accessed payment card detail to the vendor.

Specifically, step 140 comprises, in step 140a, converting the accessed payment card detail from a string (for example containing text and/or numbers) into a series of dial tones. The accessed payment card details is converted into the series of dial tones using a dual tone multi-frequency generator on the customer’s telephone. The dual tone multi-frequency generator is configured to convert the string into the series of dial tones.

The payment card detail may be a series of numbers (for example, the card number, the expiry date, and the 3 or 4 digit verification number). The series of dial tones represent the series of numbers associated with the card detail. The series of numbers are converted by converting each of the numbers in the series of numbers into a dial tone. Each of the numbers are converted into a dial tone using a dual tone multi-frequency generator. The dual tone multi-frequency generator may convert each number into a tone comprising two known frequencies.

Conventional dual tone multi-frequency keypads assign each number with two known tone frequencies. For example, the number 1 may be assigned 697 Hz and 1209 Hz; number 2 may be assigned 697 Hz and 1336 Hz; number 3 may be assigned 697 Hz and 1477 Hz; number 4 may be assigned 770 Hz and 1209 Hz; number 5 may be assigned 770 Hz and 1336 Hz; number 6 may be assigned 770 Hz and 1477 Hz; number 7 may be assigned 852 Hz and 1209 Hz; number 8 may be assigned 852 Hz and 1336 Hz; number 9 may be assigned 852 Hz and 1477 Hz; and number 0 may be assigned 941 Hz and 1336 Hz. These known frequencies can be interpreted using an interactive voice response system on the vendor’s telephone.

Other combinations of tone frequencies may be used.

Alternatively, the payment card detail may be converted to single tones.

Alternatively, the payment card detail may be converted to tones comprising more than two frequencies.

Thereafter, in step 140b, the series of dial tones representative of payment card detail is audibly relayed to the vendor during the telephone call. As used herein, ‘audibly relayed’ refers to relaying audible data, for example, in the form of dial tones.

In step 140b, the series of dial tones may optionally also be relayed to the customer whilst audibly relaying the accessed payment card detail to the vendor. Alternatively, the payment card details may be converted, using at least one text-to-speech algorithm, into an audible message comprising synthesized speech, whereby the audible message comprising synthesized speech is relayed to the customer whilst the series of dial tones are relayed to the vendor.

In step 150, the vendor’s telephone receives the series of dial tones and interprets the series of dial tones generated by the dual tone multi-frequency generator on the customer’s telephone. Alternatively or additionally, the vendor’s telephone may process the series of dial tones using an interactive voice response system on the vendor’s telephone.

Thereafter, the vendor may request another type of payment card detail and therefore the method may return to step 120c in which another input associated with another payment card detail of the selected payment card is received.

A return to step 120c may be performed until the vendor has received all required payment card details of the selected payment card.

Once the final payment card detail is received, the vendor may process the payment using the received payment card detail(s). Thereafter, in step 160, the telephone call between the customer and the vendor may be terminated.

With the above-described method, as the customer’s telephone stores the payment card detail therein and audibly relays the payment card detail to the vendor during the telephone call, the customer does not need to retrieve their payment card and therefore does not need to physically handle the payment card during the telephone call. This means that the customer may audibly relay their payment card detail whilst only interacting with their telephone. This therefore provides for a physically convenient method for relaying a payment card detail during a telephone call between a customer’s telephone and a vendor’s telephone.

Additionally, as the customer’s telephone itself audibly relays the payment card detail to the vendor, the customer themselves need not speak the payment card detail. This therefore provides for increased security as a third party cannot eavesdrop and obtain the relayed payment card detail. Hence, the method is also a secure method for relaying a payment card detail during a telephone call between a customer’s telephone and a vendor’s telephone.

Moreover, as the customer does not manually read out the payment card details, the potential for an error during the relaying of the payment card details is eliminated. This method therefore provides for an improved accuracy in relaying payment card details over the telephone. As the potential for an error has been eliminated from the customer’s side, the chances for restarting the payment process due to an error is greatly reduced thereby further improving the convenience of making a payment over the telephone.

Throughout the entire method, the customer may terminate the telephone call between the customer and the vendor. Additionally or alternatively, throughout the entire method, the customer may terminate the relaying of the payment card detail to the vendor at any stage.

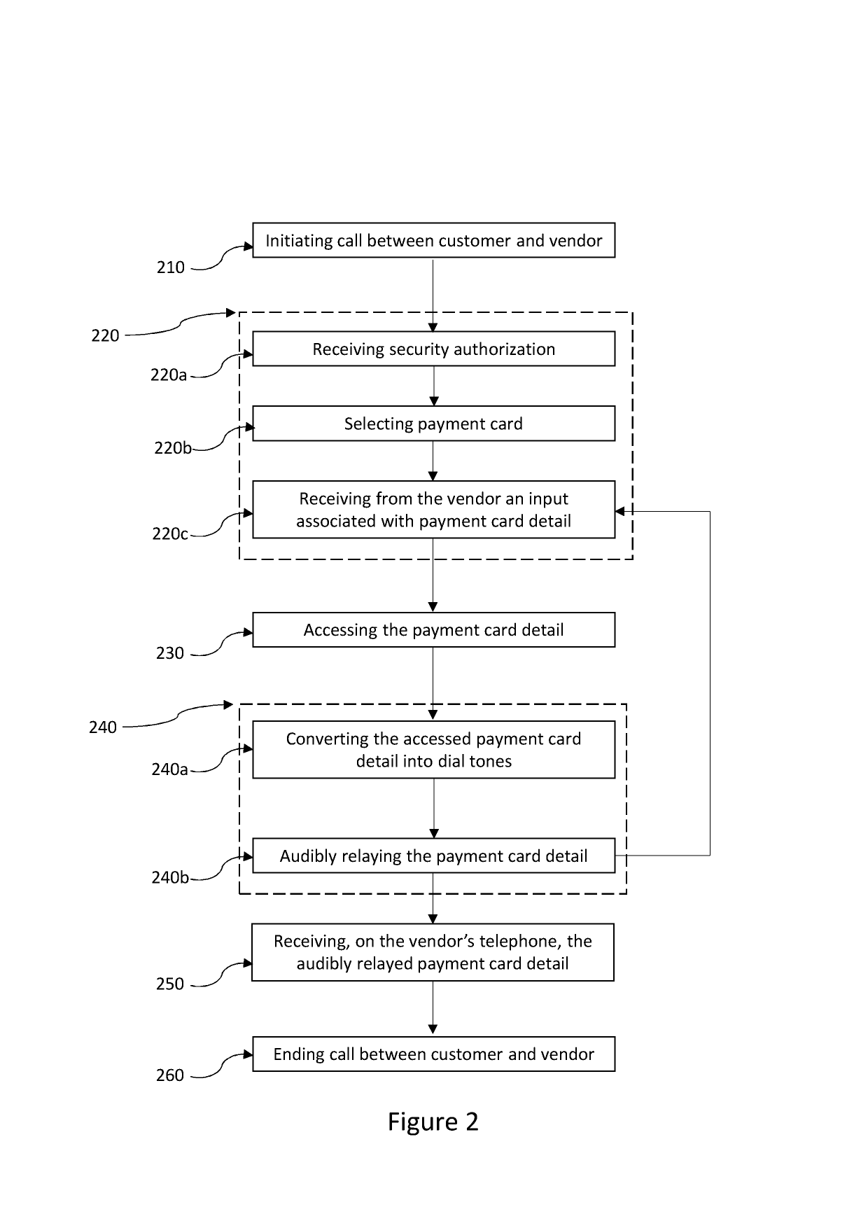

FIG. 2 shows a second implementation of a method for relaying a payment card detail during a telephone call between a customer’s telephone and a vendor’s telephone. The second implementation is similar to that shown in FIG. 1 and therefore only the differences will be discussed below.

In particular, the second implementation differs in that step 220 comprises, in step 220c, the customer’s telephone receiving an input associated with a payment card detail of the selected payment card, in which the input is received from the vendor.

Specially, in step 220c, the vendor may select an input on the vendor’s telephone, said input then being relayed to the customer’s telephone and being received by the customer’s telephone as an input.

In certain implementations, the vendor’s telephone may relay the input the customer’s telephone using dual-tone multi-frequency signaling or any other means of communication.

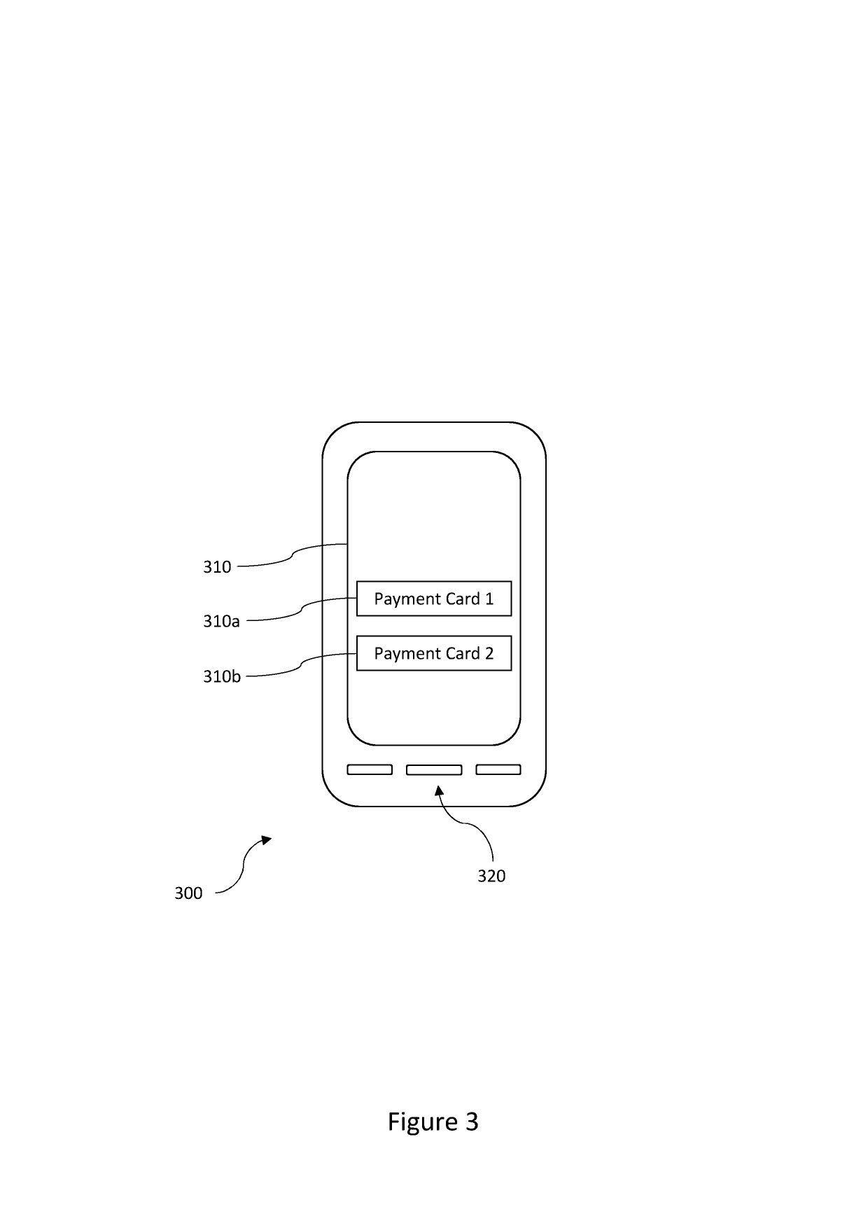

FIG. 3 shows an example of a telephone which may be used in accordance with the present disclosure. In FIG. 3, the telephone is illustrated as showing a first selection screen.

The telephone shown in FIG. 3 is a mobile telephone 300 comprising a screen 310, optionally being a touchscreen, and three pushbuttons 320. The mobile telephone 300 may be used by the customer.

The mobile telephone 300 includes a non-transitory computer readable medium (not shown) carrying executable instructions for carrying out any of the methods disclosed herein.

The mobile telephone 300 stores therein at least one set of payment card details associated with a payment card.

In the configuration shown in FIG. 3, the screen 310 shows a first selection screen which can be used in step 120b or 220b of the methods described above. In particular, the first selection screen shown on screen 310 allows the customer to select a payment card out of a first payment card and a second payment card by selecting the first payment card button 310a and the second payment card button 310b respectively.

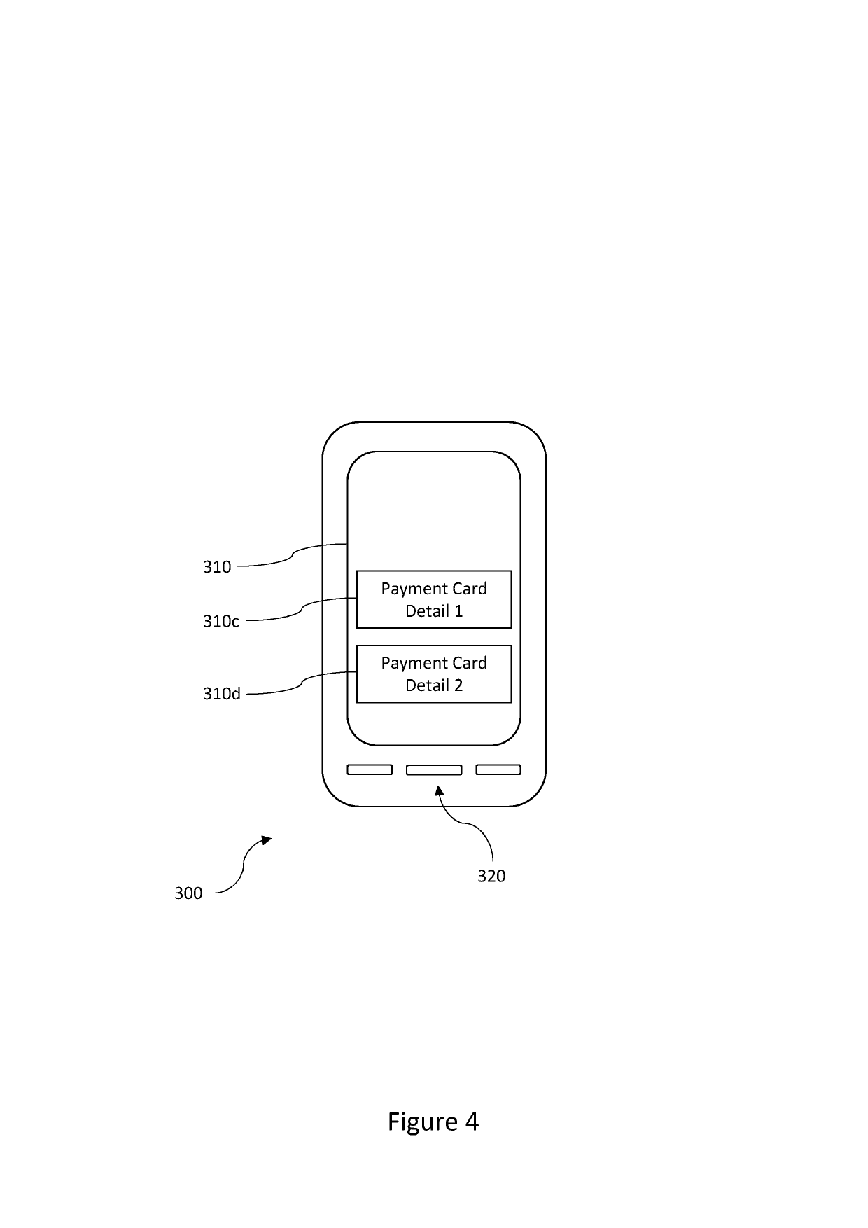

FIG. 4 shows the telephone of FIG. 3 with a second selection screen shown on the screen 310.

In the configuration shown in FIG. 4, the screen 310 shows the second selection screen which can be used in step 120c of the methods described above. In particular, the second selection screen shown on screen 310 allows the customer to select a payment card detail out of the set of payment card details associated with the selected payment card. The second selection screen allows the customer to select a first payment card detail or a second payment card detail by selecting the first payment card detail button 310c and the second payment card detail button 310d respectively.

Although the above explanation is considered to fully clarify how the present invention may straightforwardly be put into effect by those skilled in the art, it is to be regarded as purely exemplary.

For example, even though FIGS. 3 and 4 show a mobile telephone, the present disclosure may be implemented using a landline telephone which does not comprise a screen or touchscreen. For example, all inputs may be entered using a physical keypad and all outputs may be given using the telephones speaker.

Furthermore, the payment card details of the set of payment card details do not need to be audibly relayed in isolation as in FIGS. 1 and 2. Instead, after receiving a predetermined input, the customer’s telephone may access all payment card details associated with the selected payment card and audibly relay all payment card details in a plurality of series of dial tones to the vendor.

Any of the above methods may be implemented using software being part of the customer’s telephone’s operating system (such as Android or iOS) or being part of an application installed on the customer’s telephone.

In any of the above methods, the customer’s telephone may store any of the payment card details associated with payment cards on an application which is part of the customer’s telephone’s operating system (such as Android or iOS) or being part of an application installed on the customer’s telephone. For example, the customer’s payment card details may be stored on Apple Pay, Google Pay or any other application of the like.

In any of the above methods, retrieving payment card details may be optional. Alternatively, the methods may retrieve any form of personal information, for example, sensitive information, personal identification information (e.g., passport details, driver's license details, national insurance number, addresses), or any other form of personal information.

All of the above are fully within the scope of the present disclosure and are considered to form the basis for alternative embodiments in which one or more combinations of the above-described features are applied, without limitation to the specific combinations disclosed above.

In light of this, there will be many alternatives which implement the teaching of the present disclosure. It is expected that one skilled in the art will be able to modify and adapt the above disclosure to suit its own circumstances and requirements within the scope of the present disclosure, while retaining some or all technical effects of the same, either disclosed or derivable from the above, in light of his common general knowledge in this art. All such equivalents, modifications or adaptations fall within the scope of the invention hereby defined and claimed.

1. A method for relaying a payment card detail during a telephone call between a customer’s telephone and a vendor’s telephone, the customer’s telephone storing the payment card detail therein, the method comprising:
initiating a telephone call between the customer and the vendor;
the customer’s telephone receiving a predetermined input;
during the telephone call, the customer’s telephone accessing the payment card detail stored in the customer’s telephone based on the predetermined input; and
the customer’s telephone audibly relaying to the vendor the accessed payment card detail,
wherein audibly relaying to the vendor the accessed payment card detail comprises the customer’s telephone converting the accessed payment card detail into a series of dial tones and audibly relaying the series of dial tones during the telephone call, wherein the series of dial tones are representative of the accessed payment card detail.

2. The method of claim 1, wherein converting the accessed payment card detail comprises using a dual tone multi-frequency generator on the customer’s telephone.

3. The method of claim 1, wherein the dial tones are keystroke dial tones.

4. The method of claim 1, wherein receiving the predetermined input comprises the customer inputting the predetermined input using the customer’s telephone.

5. The method of claim 4, wherein the predetermined input comprises the customer selecting a key or a sequence of keys on the customer’s telephone.

6. The method of claim 1, wherein receiving the predetermined input comprises the vendor inputting the predetermined input using the vendor’s telephone and the vendor’s telephone relaying the inputted predetermined input to the customer’s telephone.

7. The method of claim 6, wherein the predetermined input comprises the vendor selecting a key or a sequence of keys on the vendor’s telephone.

8. The method of claim 1, further comprising:
the customer’s telephone receiving a second predetermined input;
during the telephone call, the customer’s telephone accessing a second payment card detail stored in the customer’s telephone based on the second predetermined input; and
the customer’s telephone audibly relaying to the vendor the accessed second payment card detail,
wherein audibly relaying to the vendor the accessed second payment card detail comprises the customer’s telephone converting the accessed second payment card detail into a second series of dial tones and audibly relaying the second series of dial tones during the telephone call, wherein the second series of dial tones are representative of the accessed second payment card detail.

9. The method of claim 1, comprising receiving security authorization from the customer using the customer’s telephone, and, optionally, wherein the security authorization is in the form of receiving a passcode/password, a fingerprint, a retinal-recognition image and/or a facial-recognition image from the customer using the customer’s telephone.

10. The method of claim 9, wherein receiving the predetermined input comprises receiving the security authorization.

11. The method of claim 1, further comprising converting, using at least one text-to-speech algorithm, the accessed payment card detail to an audible message containing the payment card detail and audibly relaying to the customer the audible message whilst audibly relaying to the vendor the series of dial tones.

12. The method of claim 1, wherein the customer’s telephone stores a first set of payment card details associated with a first payment card and comprising the accessed payment card detail and a second set of payment card details associated with a second payment card.

13. A non-transitory computer readable medium tangibly carrying computer executable instructions for relaying a payment card detail during a telephone call between a customer’s telephone and a vendor’s telephone, the customer’s telephone storing the payment card detail therein, the instructions being executable to implement:
initiating a telephone call between the customer and the vendor;
the customer’s telephone receiving a predetermined input;
during the telephone call, the customer’s telephone accessing the payment card detail stored in the customer’s telephone based on the predetermined input; and
the customer’s telephone audibly relaying to the vendor the accessed payment card detail,
wherein audibly relaying to the vendor the accessed payment card detail comprises the customer’s telephone converting, the accessed payment card detail into a series of dial tones and audibly relaying the series of dial tones during the telephone call, wherein the series of dial tones are representative of the accessed payment card detail.

14. A user device comprising:
(a) a processor and a memory, wherein the memory is configured to store one or more payment card details, including at least a first payment card detail;
(b) a display;
(c) a user interface usable by a user to provide input; and
(d) a telephone communication device configured to provide two way audio communication;
wherein the processor is configured to, as part of a payment detail relay process:
(i) establish a communication channel with a vendor via the telephone communication device;
(ii) in response to a predetermined input that indicates the start of a transaction, cause one or more graphics associated with the one or more payment card details to display via the display;
(iii) create a series of dial tones based on the first payment card detail, wherein the series of dial tones comprises audible signals describing the first payment card detail; and
(iv) in response to the user selecting a first graphic of the one or more graphics that is associated with the first payment card detail, via the user interface, audibly relay the series of dial tones over the communication channel.

15. The user device of claim 14, wherein the predetermined input is received from the vendor.

16. The user device of claim 14, wherein the predetermined input is received:
(i) from the vendor via an alternate communication channel other than the communication channel; and
(ii) while the vendor is still connected via the communication channel.

17. The user device of claim 14, wherein the predetermined input is received from the user via the user interface.

18. The user device of claim 14, wherein the payment detail relay process is configured on the user device after installation of a standalone software application on the user device.

19. The user device of claim 14, wherein the payment detail relay process is configured on the user device as an integrated feature of an operating system installed on the user device.

20. The user device of claim 14, wherein the processor is further configured to cause each of the one or more graphics to display via the display as an image of a payment card associated with that graphic.
